(19) United States
(12) Patent Application Publication
(10) Pub. No.: US 2007/0265760 A1
(43) Pub. Date: Nov. 15, 2007

(54) Driving Assistance Apparatus, Vehicle and Method for Vehicle Cruise Control

(75) Inventors: Peter Konhauser, Stuttgart (DE); Gerhard Nocker, Goppingen (DE)

Correspondence Address: FITCH, EVEN, TABIN & FLANNERY, P. O. BOX 18415, WASHINGTON, DC, 20036, US

(73) Assignee: DaimlerChrysler AG, Stuttgart (DE)

(21) Appl. No.: 10/583,406

(22) PCT Filed: Dec. 16, 2004
(86) PCT No.: PCT/EP04/14320

§ 371 Date: Jan. 9, 2007

(30) Foreign Application Priority Data
Dec. 20, 2003 (DE) 103 60 129.5

(51) Int. Cl. B60T 7/12

(52) U.S. Cl. 701/97

(57) ABSTRACT

The invention relates to a driving assistance apparatus (19) for cruise control for a vehicle (10, 27). It is proposed that the driving assistance apparatus have receiving means (25) for reception of a danger alarm (54, 70), which is transmitted without the use of wires at least outside the vehicle (10, 27), and/or of a switch-off command (35), which is formed by a transmitting/receiving device (30) in the vehicle (10, 27) from the danger alarm (54, 70), and in that the apparatus is designed for self-deactivation as a function of the danger alarm (54, 70) and/or cannot be activated as a function of the danger alarm (54, 70).

The invention relates to a driving assistance apparatus, and to a method for cruise control of a vehicle.

A driving assistance apparatus such as this is also referred to as Tempomat, or cruise control. A driver of the vehicle, for example of a passenger vehicle, can preset a preset speed of travel, at which the driving assistance apparatus regulates the speed of travel of the vehicle. For this purpose, the driving assistance apparatus controls, for example, a traction motor or engine or a motor or engine controller for a traction motor or engine in the vehicle, in an appropriate manner.

However, hazardous situations can now occur, for example as a result of rain or the like. Normally, in situations such as this, the driver himself reduces the preset speed of travel or deactivates the driving assistance apparatus entirely, for example by operation of the brake pedal or braking of the vehicle. Automatic adaptation of the preset speed of travel as a function of the amount of rain is disclosed in Japanese Patent Application 60261955. A rain sensor measures the amount of rain. The preset speed of travel is reduced or increased as a function of the amount of rain.

In order to avoid critical driving situations, remote warning appliances are also known, which are radio-assisted and receive danger alarms without the use of wires. By way of example, German Patent Specification DE 4203390 C2 and German Utility Model G 9004703.6 U1 each disclose a transmitting/receiving appliance, which is carried in the vehicle and warns the driver of the vehicle by means of visual or audible signals on approaching a danger situation, for example fog, a jam, an accident or a traffic build-up. The driver reacts to the danger situation on his own responsibility, for example by reducing the speed of travel of the vehicle.

Other danger warning appliances act actively on vehicle braking systems. For example, DE-A 3724718 proposes a danger warning appliance which automatically slowly brakes the vehicle and brings it to rest when it receives a danger alarm which is transmitted without the use of wires. The danger alarm may, for example, be installed in a fixed-position appliance or in an appliance contained in a vehicle, for example as proposed by DE 4434789 A1.

In the known driving assistance apparatuses, provision is accordingly made for the driver of the vehicle to select a suitable speed of travel by behavior for which he is himself responsible, or to actively act on the braking system of the vehicle after reception of a danger alarm, in which case the driver himself no longer has the capability for action.

The object of the present invention is thus to allow optimum matching to danger situations in the case of a driving assistance apparatus for cruise control for a vehicle.

This object is achieved by a driving assistance apparatus for cruise control for a vehicle which has receiving means for reception of a danger alarm, which is transmitted without the use of wires at least outside the vehicle, and/or of a switch-off command, which is formed by a transmitting/receiving device in the vehicle from the danger alarm, and which apparatus is designed for self-deactivation as a function of the danger alarm and/or cannot be activated as a function of the danger alarm. A method such as this is also provided.

The driving assistance apparatus according to the invention evaluates the danger alarm which, for example, is transmitted by a fixed-position transmitting device or by a vehicle transmitting device provided in a second vehicle. The second vehicle may, for example, be the preceding or approaching vehicle equipped according to the invention. The second, for example preceding, vehicle has, by way of example, detected black ice, rain, snowfall or other critical weather situations, or has reached the end of a jam, or the driver of the second vehicle has carried out an emergency braking action. The danger alarm is expediently transmitted in a locally restricted area surrounding the danger point, for example within a radius of 1 km. The driving assistance apparatus is deactivated, and no longer regulates the vehicle at a nominal speed of travel.

Furthermore, one variant of the invention provides a transmitting/receiving device for interaction with the driving assistance apparatus explained above. The transmitting/receiving device receives the danger alarm and transmits it, for example, on a bus system, for example a CAN bus, to the driving assistance apparatus. It is also feasible for the transmitting/receiving device to generate a switch-off command from the danger alarm, which switch-off command causes the driving assistance apparatus according to the invention to be deactivated or prevents the driver of the vehicle from being able to activate it.

Advantageous refinements of the invention are specified in the dependent claims and in the description.

The driving assistance apparatus can also evaluate additional parameters when it has received the danger alarm or the switch-off command. It expediently evaluates the current speed of travel of the vehicle and/or the current distance from a preceding vehicle. By way of example, a slow speed of travel or a long distance from a preceding vehicle may be provided, so that the danger induced by the danger alarm can be coped with even without deactivation or the prevention of the capability to activate the driving assistance apparatus.

A further variant of the invention provides for the driving assistance apparatus to reduce the speed of travel of the vehicle before its self-deactivation, for example in the case of an internal combustion engine by decreasing the throttle opening, as is done in particular by appropriate influencing of the throttle valve angle, the amount of fuel injected or the ignition times. The driver is thus provided with tactile feedback that a danger is present. Further warning information, for example visual or audible warning information, can also be emitted by the driving assistance apparatus according to the invention. It is expedient to emit warning information even before the deactivation, so that the driver is not surprised by the deactivation. It is then expedient to wait for a control action by the driver in order to acknowledge the warning information, or, in another variant of the invention, not to wait for this. If the driver acknowledges the warning information, for example by braking the vehicle, pushing a button or speaking a predetermined acknowledgement word, the driving assistance apparatus is deactivated, and can no longer be activated. However, a different scenario is also possible in which the driving assistance apparatus waits for a predetermined time after emitting the warning information. If the driver does not acknowledge the warning information within this time interval, self-deactivation takes place.

One particularly preferred variant of the invention provides for the driving assistance apparatus to be designed for adaptive cruise control which takes account of the distance from a preceding vehicle.

After reception of the danger alarm, the driving assistance apparatus can expediently not be activated for a predetermined latency time. This latency time may, so to speak, be restarted or triggered again if a further danger alarm arrives. Once the latency time has elapsed, the driving assistance apparatus can be activated again, which means that the driver can select a preset speed of travel for the driving assistance apparatus, at which the speed of travel is intended to be regulated. In the case of so-called adaptive cruise control (ACC), the driver can also preset the so-called nominal time interval, which defines the distance from a preceding vehicle. The basic function of adaptive cruise control is based on conventional cruise control, which is also referred to as Tempomat, and which maintains a desired speed that is predetermined by the driver. Furthermore, the adaptive cruise control can also automatically adapt the speed to changing traffic conditions by automatic acceleration, deceleration or braking. This control process thus makes it possible to maintain a distance from the preceding vehicle which is dependent on the speed. The speed is controlled by means of an electronic motor or engine power control system and/or by braking. For the purposes of adaptive cruise control, the driver of a vehicle which is equipped with a system such as this can preset a nominal speed and a nominal time interval for the preceding vehicle.

One exemplary embodiment of the invention will be explained in more detail in the following text with reference to the drawing, in which:

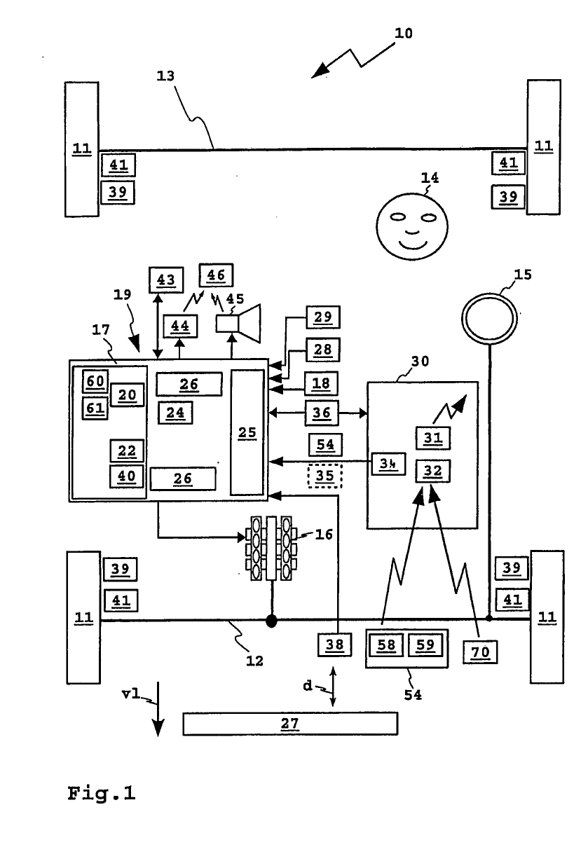

FIG. 1 shows a schematically illustrated vehicle with a driving assistance apparatus according to the invention, and

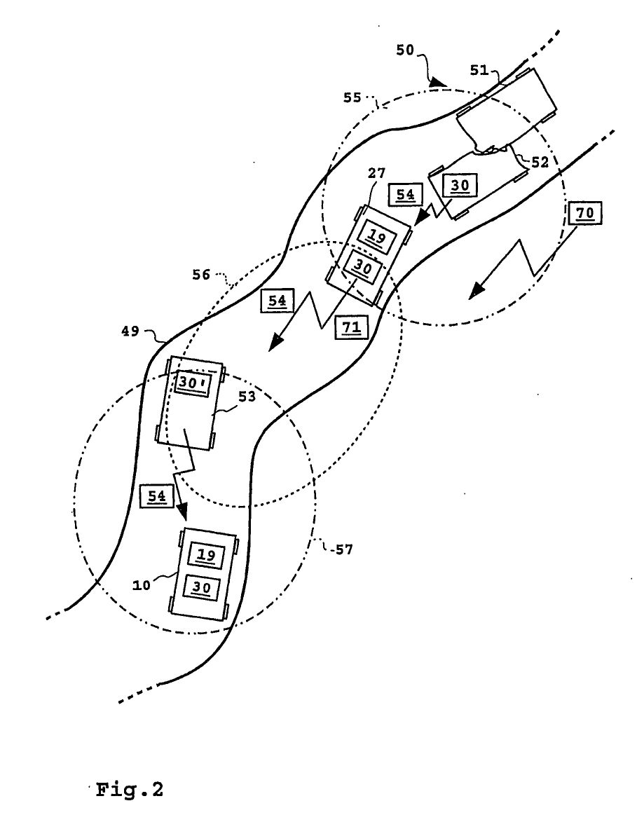

FIG. 2 shows a schematically illustrated driving situation, in which the vehicle carries out functions according to the invention as shown in FIG. 1.

FIG. 1 shows a vehicle 10 with wheels 11 on a front axle 12, and on a rear axle 13. A driver 14 can steer the wheels 11 on the front axle 12 by means of a steering wheel 15. A motor or engine 16, for example an internal combustion engine, an electric motor or the like, drives the wheels 11 on the front axle 12 and/or on the rear axle 13. A motor or engine control system 17 controls and monitors the motor or engine 16. The motor or engine control system 17 influences, for example, the fuel supply to the engine 16, the ignition times of the engine 16, or the like. The engine or motor control system 17 can also be referred to as a motor or engine controller. The driver 14 can signal or preset his forward motion wish, which inter alia may correspond to a nominal forward speed of the vehicle 10, for the motor or engine control system 17 by means of a gas pedal 18 or other preset means.

The motor or engine control system, or the motor or engine controller 17, in the exemplary embodiment forms a driving assistance apparatus 19 according to the invention. The driving assistance apparatus 19 contains an ACC module 20 as well as a motor or engine module 22, which are software modules which are stored in a memory 23, which is not illustrated for the sake of clarity, and which software modules have the program code which can be run by a processor 24 in the driving assistance apparatus 19. The driving assistance apparatus 19 also contains receiving means 25 as well as output means 26, by means of which electrical and/or visual signals can be received and output. The assemblies of the driving assistance apparatus 19 are connected to one another by means of links that are not illustrated.

The motor or engine module 22 is, for example, an electronic motor or engine power control system, which controls the motor or engine 16 in such a way that the vehicle 10 is accelerated to a speed of travel vl, or decelerated by reducing the drive power.

The ACC module 20 is a so-called adaptive cruise control module which, in addition to conventional cruise control (the so-called Tempomat function) makes it possible to maintain a distance from a preceding vehicle 27 which is dependent on the respective speed of the vehicle 10. The fundamental principles of the functionality of the ACC module were explained in the introduction in conjunction with adaptive cruise control. The respective distance d to the respectively preceding vehicle 27 is determined by a range sensor 38. However, in principle, it would also be possible for the ACC module 20 not to evaluate the distance d from a preceding vehicle 27, that is to say to operate in the form of a so-called Tempomat, and to regulate the speed of travel vl of the vehicle 10 at a preset speed of travel value.

The vehicle 10 can receive danger alarms 54, 70 by means of a radio device 30 which forms a transmitting/receiving device according to the invention for interaction with the driving assistance apparatus 19. In the exemplary embodiment, the radio device 30 is also designed to transmit danger alarms. The radio device 30 may contain known components, for example so-called WLAN (wireless local area network) transmitting and receiving means. The radio device 30 contains a transmitter 31 as well as a receiver 32 for transmission and reception, respectively, of danger alarms. The radio device 30 passes a received danger alarm 54 via an interface 34, for example a bus interface, to the driving assistance apparatus 19. It is also possible for the radio device 30 to use the danger alarm 54, 70 to generate a switch-off command 35, and to transmit this switch-off command to the driving assistance apparatus 19.

It is also possible for the radio device 30 to form a component of the driving assistance apparatus 19. In addition, a driving assistance apparatus is feasible which, for example, has a receiver in the form of the receiver 32 as the receiving device. In addition, a transmitter, for example in the form of a transmitter 31, may be provided for a driving assistance apparatus such as this.

FIG. 2 illustrates a scenario on the basis of which the method of operation of the driving assistance apparatus 19 according to the invention in conjunction with the radio device 30 will become clear. The vehicle 10 is traveling on a road 49 behind the vehicle 27 towards a danger point 50, where the vehicles 51 and 52 have collided. The vehicle 52 has a radio device 30′, in the same way as the vehicle 27 and a vehicle 53 which is approaching the vehicle 10. In addition, the vehicle 27 has a driving assistance apparatus 19, while the vehicles 51, 53 do not. The vehicle 51 is not equipped with a danger alarm radio device.

As a consequence of the collision with the vehicle 51, as has been detected for example by the initiation of airbags, vibration or the like by the radio device 30 or by an apparatus which is not illustrated but communicates with it, the radio device 30 in the vehicle 52 transmits a danger alarm 54 within a transmission area 55 which is indicated by a circle. By way of example, the maximum extent of the transmission area 55 is 300 to 500 m. However, it is also possible to define the maximum transmission area to be, for example, 1 to 2 km or the like. The vehicle 27 is located within the transmission area 55, so that its radio device 30 can receive the danger alarm 54. The driving assistance apparatus 19 in the vehicle 27, which in principle is designed in the same way as that in the vehicle 10, deactivates itself on the basis of the danger alarm 54, and no longer regulates the speed of travel of the vehicle 27 at a nominal speed of travel. Furthermore, the driving assistance apparatus 19 uses visual and/or audible output means 44, 45, for example a warning light or a loudspeaker, to emit warning information 46, in order that the driver of the vehicle 27 is aware of the danger. The driver can then, for example, brake the vehicle 27.

However, active braking action by the driving assistance apparatus 19 is also possible. For example, the driving assistance apparatus 19 can immediately operate brakes 41 on the vehicle 27. It is also feasible for the driving assistance apparatus 19 to have a so-called ESP (electronic stability program) module 40, which is provided in order to control the driving stability of the vehicle 27 or the vehicle 10. The ESP module 40 in the vehicle 27 can directly brake the vehicle 27 as a function of the danger alarm 54, that is to say once this alarm has been received. The yaw rate of the vehicle is controlled with the aid of the ESP module.

The vehicle 10 is admittedly still a relatively long way away from the danger point 50. However, the problem is that the driver 14 has preset a relatively fast nominal speed of travel 60 on the driving assistance apparatus 19 or the ACC module 20. The ACC module 20 is accordingly regulating the speed of travel vl of the vehicle 10 at the nominal speed of travel 60, so that the vehicle 10 is approaching the danger point 50 relatively quickly. The invention provides the following remedy for this dangerous situation:

The vehicle 27 relays the danger alarm 54 or a danger alarm derived from it within the transmission area 56 of its radio device 30. The vehicle 53 which is moving within the transmission area 56 can thus receive the danger alarm 54. The vehicle 53 admittedly does not have a driving assistance apparatus 19 according to the invention. However, the vehicle 53 has a radio device 30′ in the form of the radio devices 30, so that it can receive the danger alarm 54 and can relay it to further vehicles, for example to the vehicle 10. This is because the vehicle 10 is located in the transmission area 57 of the radio device 30′. Overall, the danger alarm 54 is accordingly passed from the vehicle 52 to the vehicle 10 using a vehicle-to-vehicle transmission method.

The radio device 30 transmits the danger alarm 54 via the interface 34 to the receiving means 25 for the driving assistance apparatus 19. The receiving means 25 carries out a relevance test on the danger alarm 54 in the exemplary embodiment. This is because, for example, the danger alarm 54 is irrelevant if the danger point 50 is too far away from the vehicle 10. For the relevance test, it would accordingly be possible to determine the field strength with which the danger alarm 54 was received, in order in this way to determine the distance to the danger point or to the vehicle transmitting the danger alarm 54. However, in the present exemplary embodiment, the danger alarm 54 was transmitted via a plurality of vehicles 27, 53, so that a simple field-strength measurement is not sufficient.

The driving assistance apparatus 19 accordingly evaluates position details 58, which are contained in the danger alarm 54 and indicate the position of the danger point 50. The driving assistance apparatus 19, for example the receiver means 25, compares the position details 58 with position data which defines the current position of the vehicle 10, and which is received by the driving assistance apparatus 19 from a position sensor 36, for example a GPS (global positioning system) receiver. In the present scenario, the danger alarm 54 is relevant because the vehicle 10 is within a predetermined distance of the danger point 50.

Furthermore, the driving assistance apparatus 19 evaluates danger details 59 in the danger alarm 54. The danger details 59 indicate, for example, the existence of an accident, that is to say the situation is particularly critical.

In the case of a critical situation such as this, the driving assistance apparatus 19 according to the invention, in particular the ACC module 20, will act as follows:

First of all, the ACC module 20 emits warning information 46, by means of the output means 44, 45. Furthermore, the ACC module 20 reduces the nominal speed of travel 60 to a reduced speed of travel 61, so that the vehicle 10 slows down. This slowing down of the vehicle 10 provides the driver 14 with tactile information that there is a dangerous situation. The reduction in the speed of travel 61 can be configured by the driver 14, for example on a configuration interface 43, for example a graphics user interface. It is also possible for the driving assistance apparatus 19 not to reduce the speed of the vehicle 10 when the nominal speed of travel 60 or the current speed of travel vl of the vehicle 10 is not higher than the reduced speed of travel 61.

It may be possible to configure a plurality of reduced speeds of travel 61 for the driving assistance apparatus 19, depending on the respective danger situation, for example an accident, black ice, fog or the like.

After outputting the warning information 46 and/or reducing the speed of travel of the vehicle 10, the driving assistance apparatus 19 waits for a predetermined time, in which the driver 14 can, so to speak, acknowledge the warning information 46. For example, the driver 14 can operate a brake pedal 28 in order to activate the brakes 41, thus deactivating the ACC module 20.

If the driver 14 does not react within the predetermined waiting time, the ACC module 20 deactivates itself, so that it no longer controls the vehicle 10 at the nominal speed of travel 60 or, as in the present case, at the reduced speed of travel 61. In consequence, the vehicle 10 slows down. The respective speed of travel of the vehicle 10 can then be selected directly by the driver 14, for example by appropriately pushing down the accelerator pedal 18.

The driving assistance apparatus, in particular the ACC module 20, cannot be activated for as long as the danger alarm 54 is acute. By way of example, the vehicle 52 transmits the danger alarm 54 at cyclic intervals. As long as the vehicle 10 receives these danger alarms 54, the ACC module 20 cannot be activated. After reception of each danger alarm 54, the driving assistance apparatus 19 in each case waits for a predetermined latency time before it can be activated again. The latency time is expediently longer than the cycle time of the danger alarms 54, that is to say the time between the transmission of two danger alarms 54.

It is also possible for the driver 14 to override, so to speak, the self-deactivation of the driving assistance apparatus 19 or of the ACC module 20 by a control action. The driver 14 can preset a nominal speed of travel with the aid of a speed transmitter 29, for example a pushbutton. By way of example, the driver 14 can preset the nominal speed of travel 60 by means of a predetermined operating action, for example by briefly pushing the speed transmitter 29 twice, even if the driving assistance apparatus 19 is deactivated on the basis of the danger alarm 54.

A fixed-position danger transmitter 70, which by way of example contains a fog sensor, a temperature sensor or the like, can also be provided on the road 49. The danger transmitter 70 can transmit danger alarms in the form of the danger alarm 54 and can thus, for example, signal the occurrence of ice or the like. The radio devices 30, 30′ provided in the vehicles 10, 51-53 can also transmit weather-dependent danger alarms to one another in order to signal a dangerous weather situation. For example, the ESP module 40 in the vehicle 27 has reacted to ice suddenly occurring on the road 49, and has stabilized the vehicle 27. The driving assistance apparatus 19 or the radio device 30 in the vehicle 27 then transmits a danger alarm 71 which, like the danger alarm 54, is first of all transmitted to the vehicle 53 and from there to the vehicle 10. The ACC module 20 in the vehicle 10 then deactivates itself.

It is also possible for the ACC module 20 to be deactivated as a function of the distance to the danger point, for example the danger point 50, or just to reduce the nominal speed of travel to a reduced speed of travel.

Furthermore, the ACC module 20 can evaluate the distance to a preceding vehicle, for example to the vehicle 27, on reception of a danger alarm. If, for example, the danger alarm 71 signals fog and the distance d to the vehicle 27 is sufficiently long, there is no need to deactivate the ACC module 20. However, if the distance d to the preceding vehicle 27 is too short, the ACC module 20 is deactivated.

The driving assistance apparatus 19 determines the respective speed of travel vl on the basis, for example, of wheel sensors 39 on the wheels 11.

The driving assistance apparatus 19, the radio device 30 and further apparatuses in the vehicle 10, for example the output means 44, 45, are connected to one another by links which are not illustrated, preferably on a bus system in the vehicle.

In one variant of the invention, the radio device 30 carries out a relevance check on danger alarms. For example, the radio device 30, in the form of the receiving means 25, can determine the relevance of the danger alarm 54. For this purpose, the radio device 30 evaluates, for example, the position details 58 and compares them with position data received from the position sensor 36. Furthermore, the radio device 30 can also evaluate the relevance of the danger details 59. If the danger alarm 54 is relevant, the radio device 30 transmits a switch-off command 35 to the driving assistance apparatus 19. The driving assistance apparatus 19 deactivates the ACC module 20 as a function of the switch-off command 35.

The radio device 30 uses the transmitter 31 to relate a received danger alarm, for example the danger alarm 54, to further vehicles. In this case as well, a relevance check is possible, that is to say the radio device 30 relays a danger alarm only when the respective danger alarm is also relevant for other vehicles, for example a predetermined distance to a danger point has not yet been exceeded.

In the exemplary embodiment, the driving assistance apparatus 19 comprises software and hardware. It is self-evident that a complete software or hardware embodiment is also possible.

1. A driving assistance apparatus for cruise control for a vehicle (10, 27), having receiving means (25) for reception of a danger alarm (54, 70), which is transmitted without the use of wires at least outside the vehicle (10, 27), and/or of a switch-off command (35), which is formed by a transmitting/receiving device (30) in the vehicle (10, 27) from the danger alarm (54, 70), wherein the driving assistance apparatus is designed for self-deactivation as a function of the danger alarm (54, 70) and/or cannot be activated as a function of the danger alarm (54, 70), characterized
in that the driving assistance apparatus is designed for self-deactivation and/or cannot be activated in conjunction with the danger alarm (54, 70) as a function of a current speed of travel (vl) of the vehicle (10, 27).

2. A driving assistance apparatus for cruise control for a vehicle (10, 27), having receiving means (25) for reception of a danger alarm (54, 70), which is transmitted without the use of wires at least outside the vehicle (10, 27), and/or of a switch-off command (35), which is formed by a transmitting/receiving device (30) in the vehicle (10, 27) from the danger alarm (54, 70), wherein the driving assistance apparatus is designed for self-deactivation as a function of the danger alarm (54, 70) and/or cannot be activated as a function of the danger alarm (54, 70), characterized
in that the driving assistance apparatus is designed for self-deactivation and/or cannot be activated in conjunction with the danger alarm (54, 70) as a function of the current distance (d) from a preceding vehicle (27).

3. The driving assistance apparatus as claimed in claim 1, characterized
in that the apparatus is designed for self-deactivation and/or cannot be activated in conjunction with the danger alarm (54, 70) as a function of a preset speed of travel.

4. The driving assistance apparatus as claimed in claim 1, characterized
in that the apparatus is designed to reduce the speed of travel (vl) of the vehicle (10, 27) before its self-deactivation.

5. The driving assistance apparatus as claimed in claim 1, characterized
in that the apparatus cannot be activated for a predetermined latency time after reception of the danger alarm (54, 70).

6. The driving assistance apparatus as claimed in claim 1, characterized
in that the apparatus can receive the danger alarm (54, 70) or the switch-off command (35) via a bus in the vehicle.

7. The driving assistance apparatus as claimed in claim 1, characterized
in that the danger alarm (54, 70) is transmitted by a fixed-position transmitting device (30, 70) or by a vehicle transmitting device (30, 70) provided in a second vehicle (10, 27).

8. The driving assistance apparatus as claimed in claim 1, characterized
in that the apparatus has output means for outputting in particular visual and/or audible and/or tactile warning information (46) to the driver (14) of the vehicle (10, 27).

9. The driving assistance apparatus as claimed in claim 8,
characterized
in that the output means output the warning information (46) before deactivation of the driving assistance apparatus (19).

10. The driving assistance apparatus as claimed in claim 8,
characterized
in that the self-deactivation is carried out when the driver (14) has acknowledged the warning information (46) by means of a predetermined control action.

11. The driving assistance apparatus as claimed in claim 8,
characterized
in that the self-deactivation is carried out when the driver (14) does not acknowledge the warning information (46).

12. The driving assistance apparatus as claimed in claim 1, characterized
in that the apparatus is designed for adaptive cruise control which takes account of the distance (d) from a preceding vehicle (27).

13. A transmitting/receiving device (30) for interaction with a driving assistance apparatus (19) as claimed in claim 1, characterized
in that the device has receiving means (32) for reception of a danger alarm (54, 70), which is transmitted without the use of wires at least outside the vehicle (10, 27), and in that the device has interface means (34) for transmission of the danger alarm (54, 70) and/or of a switch-off command (35), which is formed from the danger alarm (54, 70), to the driving assistance apparatus (19).

14. The transmitting/receiving device (30) as claimed in claim 13, characterized
in that the device has a program code which can be run by a processor which, in particular, is contained in a traction control apparatus and/or a motor or engine control apparatus for a traction motor or engine (16) in the vehicle (10, 27).

15. A storage means having a transmitting/receiving device (30) as claimed in claim 14.

16. A vehicle, in particular a passenger vehicle,
characterized
in that the vehicle contains a a transmitting/receiving device (30) as claimed in claim 13.

17. A method for cruise control of a vehicle (10, 27), in which a danger alarm (54, 70), which is transmitted without the use of wires at least outside the vehicle (10, 27), and/or a switch-off command (35), which is formed from the danger alarm (54, 70), are/is received, wherein the cruise control is deactivated as a function of the danger alarm (54, 70) and/or cannot be activated as a function of the danger alarm (54, 70), characterized
in that the cruise control is deactivated and/or cannot be activated in conjunction with the danger alarm (54, 70) as a function of the current speed of travel (vl) of the vehicle (10, 27).

18. A method for cruise control of a vehicle (10, 27), in which a danger alarm (54, 70), which is transmitted without the use of wires at least outside the vehicle (10, 27), and/or a switch-off command (35), which is formed from the danger alarm (54, 70), are/is received, wherein the cruise control is deactivated as a function of the danger alarm (54, 70) and/or cannot be activated as a function of the danger alarm (54, 70), characterized
in that the cruise control is deactivated and/or cannot be activated in conjunction with the danger alarm (54, 70) as a function of the current distance (d) from a preceding vehicle (27).

19. The driving assistance apparatus as claimed in claim 1, characterized
in that the apparatus has a program code which can be run by a processor which, in particular, is contained in a traction control apparatus and/or a motor or engine control apparatus for a traction motor or engine (16) in the vehicle (10, 27).

20. A storage means having a driving assistance apparatus as claimed in claim 1.

21. A vehicle, in particular a passenger vehicle,
characterized
in that the vehicle contains a driving assistance apparatus (19) as claimed in claim 1.
